(19) United States
(12) Patent Application Publication
(10) Pub. No.: US 2026/0292137 A1
(43) Pub. Date: Sep. 24, 2026

(54) Methods and Apparatus for Inheriting Cross-Component Models from Temporal and History-based Neighbours for Chroma Inter Coding

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/472,335

(22) PCT Filed: Jul. 5, 2024
(86) PCT No.: PCT/CN2024/104001

§ 371 Date: Oct. 3, 2025

Related U.S. Application Data
(60) Provisional application No. 63/511,922, filed on Jul. 5, 2023.

(51) Int. Cl. H04N 19/105; H04N 19/176; H04N 19/186

(52) U.S. Cl. CPC H04N 19/105; H04N 19/176; H04N 19/186

(57) ABSTRACT

A method and apparatus for coding colour pictures using coding tools including one or more cross component models related modes are disclosed. According to this method, one or more cross-component prediction candidates are determined based on one or more cross-component models inherited from one or more previously coded slices or pictures or from a current picture. A candidate list comprising said one or more cross-component prediction candidates is derived. The second-colour block is encoded or decoded by using the candidate list, wherein when a target cross-component prediction candidate is selected to code the second-colour block, prediction data for the second-colour block is generated by applying a corresponding cross-component model to the first-colour block.

### CROSS REFERENCE TO RELATED APPLICATIONS

The present invention is a non-Provisional application of and claims priority to U.S. Provisional Patent Application No. 63/511,922, filed on Jul. 5, 2023. The U.S. Provisional patent application is hereby incorporated by reference in its entirety.

### FIELD OF THE INVENTION

The present invention relates to video coding system. In particular, the present invention relates to cross-component prediction for a chroma component by inheriting temporal and/or history-based cross-component model.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

The VVC standard incorporates various new coding tools to further improve the coding efficiency over the HEVC standard. Some new tools relevant to the present invention are reviewed as follows.

In order to improve the coding performance for a system using cross-component models, methods and apparatus of deriving cross-component prediction candidates based on one or more cross-component models inherited from one or more previously coded slices or pictures or from a current picture are disclosed.

### BRIEF SUMMARY OF THE INVENTION

A method and apparatus for coding colour pictures using coding tools including one or more cross component models related modes are disclosed. According to this method, input data associated with a current block comprising a first-colour block and a second-colour block is received, wherein the input data comprises pixel data to be encoded at an encoder side or data associated with the current block to be decoded at a decoder side, and wherein the current block is coded in an inter mode or IBC (Intra Block Copy) mode. One or more cross-component prediction candidates are determined based on one or more cross-component models inherited from one or more previously coded slices or pictures or from a current picture. A candidate list comprising said one or more cross-component prediction candidates is derived. The second-colour block is encoded or decoded by using the candidate list, wherein when a target cross-component prediction candidate is selected to code the second-colour block, prediction data for the second-colour block is generated by applying a corresponding cross-component model to the first-colour block.

In one embodiment, target cross-component models are inherited from one or more collocated blocks in said one or more previously coded slices or pictures, and said one or more collocated blocks are indicated by inter mode information. In one embodiment, the collocated block is indicated by the inter mode information of the current block. In one embodiment, if the current block is coded in a subblock motion mode, one or more subblock temporal candidates corresponding to one or more subblock temporal cross-component models inherited from one or more collocated blocks indicated by the inter mode information of said one or more subblocks are added to the candidate list. In another embodiment, the collocated block is referred by the inter mode information of one or more neighbouring blocks of the current block.

In one embodiment, said one or more cross-component prediction candidates are located at one or more pre-defined positions in said one or more previously coded slices or pictures according to current location of the current block, current block width, current block height, or a combination thereof. In one embodiment, said one or more pre-defined positions are inside a corresponding area of the current block or said one or more pre-defined positions are outside the corresponding area of the current block. In one embodiment, a first set of values and a second set of values are determined, and said one or more pre-defined positions comprise one or more offset locations from the current location of the current block, and wherein said one or more offset locations comprise the first set of values scaled by the current block width for a horizontal direction, the second set of values scaled by the current block height for a vertical direction, or both.

In one embodiment, a collocated picture is determined, and wherein the collocated picture corresponds to a target previously coded picture that a target cross-component model is inherited from. In one embodiment, the collocated picture corresponds to one of reference pictures in one or more reference lists. In one embodiment, the collocated picture is selected according to a reference index and a target reference list signalled in or parsed from a picture header or a slice header. In one embodiment, the collocated picture is selected as a target reference picture in one or more reference lists, and POC (Picture Order Count) difference or QP (Quantization Parameter) difference between the target reference picture and a current picture is the smallest. In one embodiment, the collocated picture corresponds to a most recently coded I-picture.

In one embodiment, both the collocated picture and positions of said one or more cross-component prediction candidates or only the positions of said one or more cross-component prediction candidates are determined according to a motion vector of a neighbouring block or the current block. In one embodiment, when the collocated picture corresponds to a target reference picture associated with the motion vector of the neighbouring block or the current block, the positions of said one or more cross-component prediction candidates are determined according to the motion vector of the neighbouring block or the current block shifted by a set of pre-defined values. In another embodiment, the positions of said one or more cross-component prediction candidates are determined according to a scaled motion vector shifted by a set of pre-defined values, and wherein the scaled motion vector is derived based on the motion vector of the neighbouring block scaled by a ratio of a first POC (Picture Order Count) distance for a current reference picture and a second POC distance for the collocated picture.

In one embodiment, the neighbouring block is selected from a pre-defined position. In one embodiment, if the neighbouring block at the pre-defined position is not an inter block, the neighbouring block is not used to derive said one or more cross-component prediction candidates.

In one embodiment, the neighbouring block is selected from a set of pre-defined positions according to a pre-defined checking order. In one embodiment, a first neighbouring block, according to the pre-defined checking order, having a corresponding reference picture being the collocated picture is selected as the neighbouring block.

In one embodiment, positions of said one or more cross-component prediction candidates are determined according to a block vector of a neighbouring block or the current block. In another embodiment, the positions of said one or more cross-component prediction candidates are determined according to a block vector shifted by a set of pre-defined values.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows 16 gradient patterns for GLM.

FIG. 3 shows an exemplary system block diagram for Cross-component residual model (CCRM).

FIG. 4 illustrates an example of template and its reference samples used in TIMD.

FIG. 5 illustrates the 5 neighbouring blocks used for deriving spatial merge candidates for VVC.

FIG. 6 illustrates an exemplary pattern of the non-adjacent spatial merge candidates.

FIG. 7 illustrates an example of temporal candidate derivation, where a scaled motion vector is derived according to POC (Picture Order Count) distances.

FIG. 8 illustrate the positions for the temporal candidate selected between candidates C₀ and C₁.

FIG. 9 illustrates an example of the reference region to derive proposed weighting setting according to an embodiment of the present invention.

FIG. 10 illustrates an example of inheriting temporal neighbouring model parameters.

FIGS. 11A-B illustrates two search patterns for inheriting non-adjacent spatial neighbouring models.

FIGS. 12A-B illustrate examples for constructing the history table of the current region from the history table of the region having the same beginning geometric position of the current region (FIG. 12A) or from the history table of the region containing the centre geometric position of the current region (FIG. 12B).

FIG. 13 illustrates an example of restricting temporal candidates to only refer the CCM information in the collocated CTU, in Area1, in Area2 or in Area3.

FIG. 14 illustrates a flowchart of an exemplary video coding system that derives cross-component prediction candidates based on cross-component models inherited from previously coded slices or pictures or from a current picture for chroma coding according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the 30 invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The terms of {LM_LA, LM_L, LM_A} and {CCLM_LT, CCLM_L, CCLM_T} are used interchangeably in this disclosure.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′_{L} [x,y]<=Threshold is classified into group 1; while a neighbouring sample with Rec′_{L}[x,y]>Threshold is classified into group 2.

$$\{ \begin{matrix}P r e {d}_{C} [ x , y ] = {α}_{1} \times {Rec}_{L}^{′} [ x , y ] + {β}_{1} & if {Rec}_{L}^{′} [ x , y ] \leq Threshold \\ P r e {d}_{C} [ x , y ] = {α}_{2} \times {Rec}_{L}^{′} [ x , y ] + {β}_{2} & if {Rec}_{L}^{′} [ x , y ] \leq Threshold\end{matrix} \qquad ( 2 )$$

### Local Illumination Compensation (LIC)

Local Illumination Compensation (LIC) is a method to do inter predict by using neighbour samples of current block and reference block. It is based on a linear model using a scaling factor a and an offset b. It derives the scaling factor a and an offset b by referring to the neighbour samples of current block and reference block. Moreover, it's enabled or disabled adaptively for each CU.

For more detail for LIC, it can refer to the document JVET-C1001 (Jianle Chen, et al., “Algorithm Description of Joint Exploration Test Model 3”, Joint Video Exploration Team (JVET) of ITU-T SG 16 WP 3 and ISO/IEC JTC 1/SC 29/WG 11, 3rd Meeting: Geneva, CH, 26 May-1 Jun. 2016, Document: JVET-C1001).

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term.

Output of the filter is calculated as a convolution between the filter coefficients and the input values and clipped to the range of valid chroma samples.

The filter coefficients are calculated by minimising MSE between predicted and reconstructed chroma samples in the reference area.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

For signalling, when the CCLM mode is enabled for the current CU, two flags are signalled separately for Cb and Cr components to indicate whether GLM is enabled for each component; if the GLM is enabled for one component, one syntax element is further signalled to select one of 16 gradient filters (210-240) for the gradient calculation as shown in FIG. 2. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Intra Block Copy

Intra block copy (IBC) is a tool adopted in HEVC extensions on screen content coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### Cross-Component Residual Model (CCRM)

As in JVET-AD0108 (Pekka Astola, et. al., “AHG12: Cross-component residual model (CCRM) for inter prediction”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0108), it is to apply cross-component residual model (CCRM) to predict chroma samples from reconstructed luma samples when the block uses inter prediction or intra block copy (IBC). FIG. 3 illustrates the decoder side of the method. The cross-component filters are derived using the prediction signals of luma and chroma. The derived filters are applied to the reconstructed luma signal producing the final chroma predictions. The input to the filter consists of 6 spatial luma samples, a nonlinear term, and a bias term. Filter coefficients are derived in step 320 for each block separately using the prediction signals (i.e., predY 310, predCb 312 and predCr 314) and the filters are applied to the reconstructed luma signal in step 330 as shown in FIG. 3. The reconstructed luma signal is formed by combining the luma prediction (PredY) 310 and residual luma signal (resY) using an adder 322. After applying the filters, the step 330 generates filtered-predicted Cb 340 and filtered-predicted Cr 350. The reconstructed Cb signal is formed by combining the filtered-predicted Cb 340 and residual Cb signal (i.e., resCb) using an adder 342. Similarly, the reconstructed Cr signal is formed by combining the filtered-predicted Cr 350 and residual Cr signal (i.e., resCr) using an adder 352.

### Chroma DM Mode

For Chroma DM mode, the intra prediction mode of the corresponding (collocated) luma block covering the centre position of the current chroma block is directly inherited.

### Decoder Side Intra Mode Derivation (DIMD)

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

### Template-Based Intra Mode Derivation (TIMD)

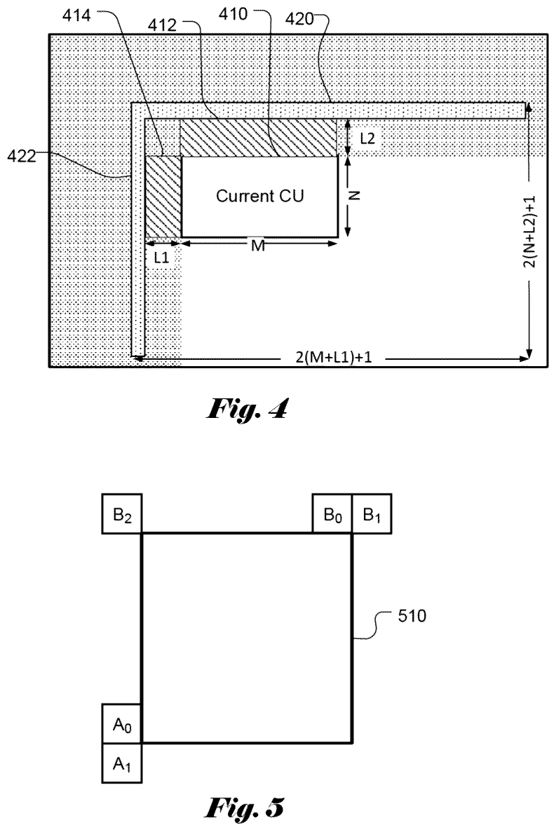

Template-based Intra Mode Derivation (TIMD) mode implicitly derives the intra prediction mode of a CU by using a neighbouring template at both the encoder and decoder, instead of signalling exact intra prediction mode bits to the decoder. As shown in FIG. 4, the prediction samples of the template are generated using the reference samples of the template for each candidate mode. A cost is calculated as the SATD between the prediction and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list. As shown in FIG. 4, the prediction samples of the template (412 and 414) for the current block 410 are generated using the reference samples (420 and 422) of the template for each candidate mode.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### Inter Prediction Overview

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional candidates introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from a FIFO table
4) Pairwise average MVP
5) Zero MVs.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 510 are selected among candidates located in the positions depicted in FIG. 5. The order of derivation is B₀, A₀, B₁, A₁ and B₂. Position B₂ is considered only when one or more neighbouring CU of positions B₀, A₀, B₁, A₁ are not available (e.g., belonging to another slice or tile) or is intra coded. After candidate at position A₀ is added, the addition of the remaining candidates is subject to a redundancy check which ensures that candidates with the same motion information are excluded from the list so that coding efficiency is improved.

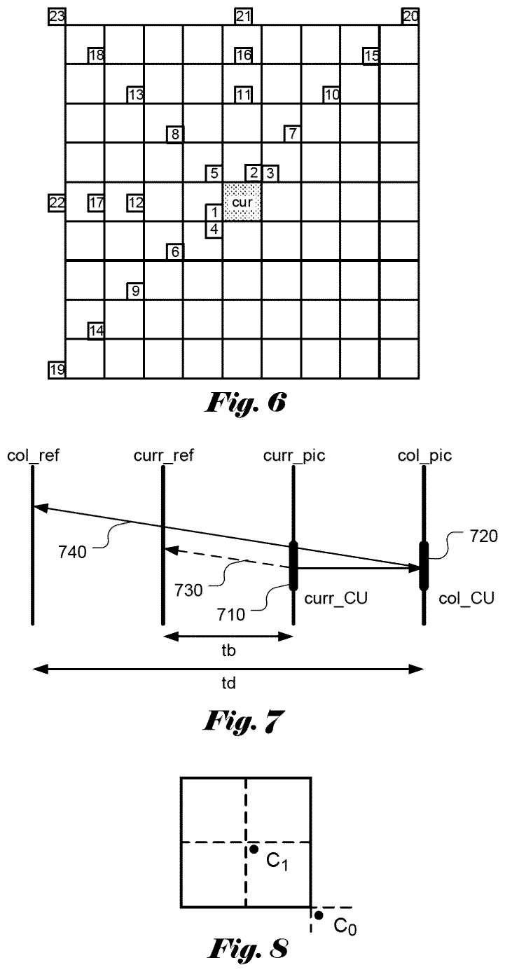

In addition to the above-mentioned spatial candidates, the non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. The pattern of spatial merge candidates is shown in FIG. 6. The distances between non-adjacent spatial candidates and current coding block are based on the width and height of current coding block. The line buffer restriction is not applied.

### Temporal Candidates Derivation

In this step, only one candidate is added to the list. Particularly, in the derivation of this temporal merge candidate for a current CU 710, a scaled motion vector is derived based on the co-located CU 720 belonging to the collocated reference picture as shown in FIG. 7. The reference picture list and the reference index to be used for the derivation of the co-located CU is explicitly signalled in the slice header. The scaled motion vector 730 for the temporal merge candidate is obtained as illustrated by the dotted line in FIG. 7, which is scaled from the motion vector 740 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 8. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate is defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge Estimation Region (MER) allows independent derivation of merge candidate list for the CUs in the same merge estimation region (MER). A candidate block that is within the same MER as the current CU is not included for the generation of the merge candidate list of the current CU. In addition, the updating process for the history-based motion vector predictor candidate list is updated only if (xCb+cbWidth)>>Log2ParMrgLevel is greater than xCb>>Log2ParMrgLevel and (yCb+cbHeight)>>Log2ParMrgLevel is great than (yCb>>Log2ParMrgLevel) and where (xCb, yCb) is the top-left luma sample position of the current CU in the picture and (cbWidth, cbHeight) is the CU size. The MER size is selected at encoder side and signalled as log2_parallel_merge_level_minus2 in the sequence parameter set.

In order to improve the coding performance of cross-component prediction, various schemes are disclosed.

The cross-component information is used to improve prediction accuracy of an inter block. To improve the prediction accuracy of the chroma component of the inter block, the luma information from the corresponding luma component and/or the chroma information from the previous coded (i.e., encoded or decoded) chroma component are used.
The first scheme is that for a coding unit (under single tree splitting) including luma (Y) and chroma (Cb and/or Cr) components, the prediction for Cb and/or Cr is improved by using the information from Y.
The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by using the information from Cb. For example, deriving model parameters by using neighbouring reconstructed samples of Cb and Cr as the inputs X and Y of model derivation. Then generating Cr prediction by the derived model parameters and Cb reconstructed samples.

In the following, several embodiments related to the first scheme are proposed to use an inherited cross-component mode for the current chroma block by a) building a candidate list for the current block where the candidate list includes cross-component models, b) selecting one or more model information in the list, and c) using the model information (similar to intra chroma cross-component mode) to generate one or more hypotheses of predictions for the current chroma component (Cb or Cr) by applying and/or modifying the selected model information to the reconstructed or predicted samples for the corresponding luma component. When the selected model information refers to traditional cross-component linear model(s), the proposed method is called as inter cross-component linear model (inter CCLM) mode. When the selected model information refers to convolutional cross-component model(s) derived by a regression-based method (as CCCM for example), the proposed method is called as inter cross-component convolution model (inter CCCM) mode. Moreover, in some embodiments, a self-derived (re-derived) cross-component mode is proposed and can be added into the candidate list in step a) “building a candidate list for the current block where the candidate list includes cross-component models”. In some embodiments, the selection of using the proposed inherited mode and/or using the proposed self-derived mode is determined following an explicit rule, an implicit rule, or both. More details are described in the section entitled “IV. Selection of Using the Proposed Inherited Mode and/or Self-Derived Mode”.

In one embodiment, the proposed embodiments can also be used for the second scheme by using the previous coded chroma component (Cb) as the luma component in the first scheme.

### Storage of the Model for the Current Block

In another embodiment, when the current inter block uses the model parameters from the self-derived cross-component mode, the used model parameters can be saved and/or reference by the following coding blocks.

In another embodiment, when the current inter block uses the inherited cross-component mode, the used model parameters can be saved and/or reference by the following coding blocks.

### I. Building a Candidate List Including Cross-Component Models

In one embodiment, when building the merge-like candidate model list (modelList), one or more of the following candidate model information are included.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In one sub-embodiment of the candidate type being “Spatial model information from spatial neighbour blocks”, a valid spatial neighbouring block(s) can be from one of spatial adjacent and non-adjacent neighbours (or any subset of the blocks in a neighbouring search region for the current block) which satisfies a pre-defined condition. For example, the pre-defined condition is that the neighbour is coded by a cross-component mode (such as CCLM, MMLM, CCCM, GLM, the mode with mode information inherited from a merge-like candidate list, MH CCLM, and/or any cross-component mode with syntax not belonging to tradition intra prediction modes) or a mode combining with cross-component modes (such as chroma fusion (or named LM assisted Angular/Planar Mode), inter CCLM, inter CCCM, and/or any traditional mode with syntax not belonging to cross-component modes but using the cross-component information to generate the prediction). When scanning the spatial neighbouring blocks, a candidate is added into the list if the candidate is valid.

In another sub-embodiment of the candidate type being “Temporal model information from collocated blocks”, the collocated block is from the block in the reference picture as inter mode. For example, when the current block is coded by inter prediction mode, the collocated block is referred by the motion information (including the motion vectors and the reference picture) of the current block. If the current block is a subblock motion mode (e.g., affine mode), each subblock in the current block has its own collocated temporal model information and/or all or any subset of collocated temporal model information referred by the different subblock motions are added into the list. For another example, the temporal model information can be from the collocated block referred by the motion information of the neighbouring blocks for the current block. If the proposed methods are applied to an IBC block or any mode using block vectors, block vector information is used as motion vector where the block vector information is determined by signalling and/or template matching in a pre-defined searching range and/or any implicit or explicit pre-defined rules.

In another sub-embodiment of the candidate type being “History-based model information”, a history-based table (the FIFO table) is built and stores the model information from the previous coded blocks. The table can be reset at the beginning and/or end of a CTU, slice, picture, tile, and/or sequence. One or more history-based candidates can be added into the candidate list by the order from the head to tail of the table or from the tail to head of the table.

In another sub-embodiment of the candidate type being “Pairwise average model information”, the model information of this candidate is derived based on the model information from more than one of the previous candidates in the list. For example, it can average and/or modify the model parameters of more than one candidate as the to-be-applied model parameters. For another example, it can combine more than one prediction as the final prediction, where each of more than one prediction is generated by applying one of models in the candidate list.

In another sub-embodiment, the default model information is added if the list is not full after inserting all pre-defined candidates. Some examples of the default CCLM model information are shown below:
For example, the default alpha (or named as α, a, or scaling parameters) are {0, 1/8, −1/8, 2/8, −2/8, 3/8, −3/8, . . . }, and the beta (or named as β, b, or offset parameter) is based on the selected default alpha, average neighbouring reconstructed luma sample value, and average neighbouring reconstructed chroma (Cb/Cr) sample value.

In another embodiment, when building modelList, one or more self-derived cross-component candidates are included. In one sub-embodiment, an example of the self-derived cross-component candidate is CCRM. The cross-component prediction (containing target predicted samples) of the current bock is formed by combining one or more proposed source terms and the models (referring to a proposed weighting setting). As shown in Equation (3), pred (i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Equation (3) is just an example and our proposed mechanism can use any subset or extension of sourceTermSet0, sourceTermSet1, and biasTermSet. Each sample or any subset of samples in the current block gets its target (predicted) sample according to Equation (3):

$$pred ( i , j ) = ( s o u r c e T e r m S e t 0 ( i , j ) + sourceTermSet 1 ( i , j ) + … + biasTerm ) \qquad ( 3 )$$

with the proposed weighting setting, where (i, j) is a sample position in the current block. The content of sourceTermSet0 is described in Section I.1, the content of sourceTermSet1 is described in Section 1.2, the content of biasTermSet is described in Section I.3, and the predictor derivation using the proposed source terms and the proposed weighting setting is described in Section I.4.
I.1. Content of source TermSet0(i, j)

SourceTermSet0(i, j) includes one or more luma source terms denoted as source Term00, sourceTerm01, . . . , and/or sourceTerm0n−1. The value of n means the number of taps for the source term set. In one embodiment, the source terms can be linear terms and/or non-linear terms, only linear terms, and/or only non-linear terms. In another embodiment, the pattern of the n taps refers to a pattern defined as any subset of a window region M×N around/including the position (iL, jL). If the target sample is chroma (e.g., Cb or Cr), (iL, jL) is the collocated luma position from (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, since the target sample belongs to a chroma sample (e.g., Cb or Cr)), the predicted sample and/or the reconstructed sample is located within the collocated (luma) block from the current (chroma) block. The predicted sample and/or the reconstructed sample is treated as an initial sample and used as source content to generate the target sample.

In another embodiment, the values of the source terms are further adjusted (e.g., added or subtracted) by a pre-defined offset.

In another embodiment, the source term may further include location information.

I.2. Content of sourceTermSet1(i, j)

SourceTermSet1(i, j) includes one or more chroma (Cb or Cr) source terms denoted as source Term0₀, sourceTerm0₁, . . . , and/or sourceTerm0ₘ₋₁. The value of m means the number of taps for the source term set. In one embodiment, the source terms can be linear terms and/or non-linear terms, only linear terms, and/or only non-linear terms. In another embodiment, the pattern of the m taps refers to a pattern defined as any subset of a window region M2×N2 around/including the position (i_{C}, j_{C}). If the target sample is chroma (Cb or Cr), (i_{C},j_{C}) is (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, if the target sample belongs to a chroma sample, the predicted sample and/or the reconstructed sample is located within the current block. The predicted sample and/or the reconstructed sample is treated as an initial sample and used as source content to generate the target sample.

In another embodiment, the values of the source terms are further adjusted (e.g., added or subtracted) by a pre-defined offset.

In another embodiment, the source term may further include location information. For example, if the target sample refers to chroma, the horizontal location (i) of (i, j) is used in a source term and the vertical location (j) of (i, j) is used in a source term.

I.3. Content of biasTermSet

Bias term is a pre-defined value. In one embodiment, the bias term is a midValue according to bitDepth specified in the standard. For example, the bias term is set as (1<<(bitDepth−1)). In another embodiment, the bias term is the same for each sample in the current block. That is, the bias term is regardless of the position (i, j).

### I.4. Predictor Derivation for Sample (i, j)

### I.4.1. Proposed Weighting Setting

The proposed weighting setting is to estimate the relationship (minimize the distortion) between “the predicted and/or reconstructed samples on the reference region of the current (chroma) block” and “the predicted and/or reconstructed samples on the reference region of the corresponding luma block” by a pre-defined regression method, and to generate a weighting (referring to model parameters) according to the regression method. The weighting of the source terms derived is then applied to get the target (predicted) samples in the current block. In one embodiment, the pre-defined regression method can be Linear Minimum Mean Square Error (LMMSE) method for CCLM or can be any unified method with the regression method used for CCLM. In another embodiment, the pre-defined regression method can be the LDL decomposition method for CCCM or can be any unified method with the regression method used for CCCM. In another embodiment, the pre-defined regression method can be Gaussian elimination.

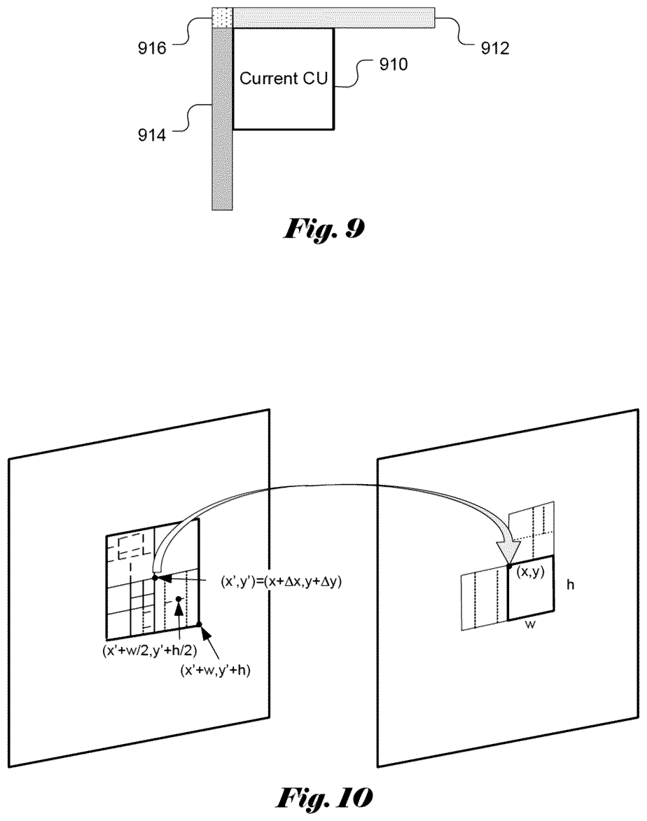

In one embodiment, the reference region of the current block is the spatial neighbouring region of the current block. The spatial neighbouring region of the current block 910 includes above reference region 912, left reference region 914, above-left reference region 916, and/or any subset of the above as shown in FIG. 9.

The reference region of the corresponding luma block is the spatial neighbouring region of the corresponding luma block.

In another embodiment, the reference region of the current block is the vector-collocated region of the current block, where the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information (motion vectors and reference pictures) of the corresponding luma block. For IBC or intraTMP, the vector-collocated region of the current block refers to the motion compensated results obtained by using the motion information (block vectors and current picture) of the current block, and the vector-collocated region of the corresponding luma block refers to the motion compensated results obtained by using the motion information (block vectors and current picture) of the corresponding luma block.

In another embodiment, the above-proposed two kinds of the reference region of the current block can be used together. For example, generally, samples in the vector-collocated region of the current block are used as input samples when deriving model parameters; however, for a smaller block, samples in the spatial neighbouring reference region are used as additional input samples when deriving model parameters.

In another embodiment, more details of construction of the modelList can be found in Section VI.

### II. Signalling for Model Information Control

When not applying the proposed inter CCLM (or inter CCCM), the prediction of current block is from the original inter prediction.

In another embodiment, whether to apply inter CCLM (or inter CCCM) or not depends on signalling.

In one sub-embodiment, the signalling refers to a coded TU/TB/CU/CB level flag. In another embodiment, inter CCLM (or inter CCCM) can be supported only when the size conditions of the current block are satisfied.

In one sub-embodiment, the size condition is that the block width, block height, or block area is larger than a pre-defined threshold. The predefine threshold can a positive integer such as 8, 16, 32, 64, 128, 256, . . . .

In another sub-embodiment, the size condition is that the block width, block height, or block area is smaller than a pre-defined threshold. The predefine threshold can a positive integer such as 8, 16, 32, 64, 128, 256, 512, 1024, 2048, 4096 . . . .

In another embodiment, original inter prediction (generated by motion compensation) is used for luma and the predictions of chroma components are generated by CCLM and/or any other LM modes.

In one sub-embodiment, the current CU is viewed as an inter CU, intra CU, or a new type of prediction mode (neither intra nor inter).

In another embodiment, the one or more LM mode(s) (or cross-component mode(s)) which will be used to generate the one or more hypotheses of predictions for LM assisted

Angular/Planar Mode/inter CCLM/inter CCCM/MH CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled and/or, can be inferred as 0 or a default value.

In one embodiment, when building modelList, one or more predefined candidates are added. The pre-defined candidates can include any subset/extension of the following candidates:
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g., IBC merge or IBC AMVP or any IBC mode under IBC syntax). (“inter” in this invention can be changed to IBC.) That is, for chroma components, the block vector prediction can be combined or replaced with cross-component prediction.

### III. Generating Hypotheses of Predictions

### III.1. Concept

In one embodiment, prediction or reconstruction-based model is used to generate one hypothesis of prediction for the current chroma component.

In one embodiment for a prediction based linear model, the derived model parameters are applied to the predicted samples for the first component (Y) to get the predicted samples for the second or third component:

$$P ( i , j ) = a \cdot {pred}_{L}^{′} ( i , j ) + b .$$

The predicted samples for the first component are downsampled with the downsampling filters (which may be fixed at one predefined filter or selected among some candidate filters).

In another sub-embodiment of a reconstruction based linear model, the derived model parameters are applied to the reconstructed samples for the first component (Y) to get the predicted samples for the second or third component:

$$P ( i , j ) = a \cdot {reco}_{L}^{′} ( i , j ) + b .$$

The reconstructed samples for the first component are down-sampled with the downsampling filters (which may be fixed at one predefined filter or selected among some candidate filters).

Prediction or reconstruction based convolution model is similar to the proposed methods for the prediction or reconstruction based linear model. The main difference is that the model coefficient pattern follows CCCM (not CCLM) and the luma samples may or may not be down-sampled first. If not applying down-sampling to the luma samples, more taps (model coefficients) may be used to access the non-down-sampled luma samples.

### III.2. CCLM for Inter Block

CCLM for inter block can also be named as inter CCLM and “CCLM” can be extended to any LM mode (or any cross-component mode) or replaced with any LM mode (or any cross-component mode). When convolutional cross-component models derived by a regression-based method is used, CCLM for inter block can also be named as inter CCCM.

In one embodiment, for chroma components, in addition to original inter prediction (generated by motion compensation which can be uni-prediction and/or bi-prediction, multiple hypotheses of prediction from multiple motion candidates which may refer to one or more merge candidates and/or one or more AMVP candidates, and/or any combination of above, or which can be only uni-prediction), one or more hypotheses of predictions (generated by CCLM and/or any other LM modes) are used to output the current prediction.

In one sub-embodiment, the current prediction is the weighted sum of inter prediction and CCLM prediction.

In another embodiment, the inter prediction can be generated by any inter mode mentioned above. For example, the inter mode can be regular merge mode. For another example, the inter mode can be CIIP mode. For another example, the inter mode can be GPM or any GPM variations (e.g., GPM intra referring one prediction unit using intra prediction).

In another embodiment, inter CCLM is supported only when any one (or more than one) of the pre-defined inter mode is used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

IV. Selection of Using the Proposed Inherited Mode and/or Self-Derived Mode

In one embodiment, a flag can be signalled to indicate/select if the re-derived model is used. If the flag is 0, the cross-component model used to encode the neighbour merge candidate is inherited. If the flag is 1, the re-derived method is used.

In another embodiment, an implicit rule (not using the additional flag) is used to determine whether to use the re-derived model.

In another embodiment, when the proposed inherited method is used, the candidate with the smallest cost (e.g., the first candidate in the modelList) is implicitly selected to generate the cross-component prediction. For another example, an index is signalled to select one or more candidates from the modelList. More details can be found in Section II.

### V. Details of Cross-Component Model Information in Candidate List

### V.1. Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM), model index for indicating which model shape is used in convolutional model, classification threshold for multi-model, information to indicate non-downsampled samples are used in convolutional model, down-sampling filter flag, down-sampling filtering index when multiple down-sampling filters are used, number of neighbouring lines used to derive model, types of templates used to derive model, post-filtering flag and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consists of one spatial term in centre position, two gradient terms for horizontal direction and vertical direction, two location term X and Y for the relative horizontal location and relative vertical location, one non-linear term and one bias term. A prediction mode can be stored in the CCM information to indicate that the inherited model is a GL-CCCM model.

### V.2. Inheriting Spatial Neighbouring Model Parameters

In one embodiment, the inherited model parameters can be from a block that is an immediate neighbouring block. The models from blocks at pre-defined positions are added into the candidate list in a pre-defined order.

In one embodiment, the pre-defined positions and the pre-defined order can be the same as those of spatial candidates for inter merge mode.

In one embodiment, the pre-defined positions can be the positions depicted in FIG. 5. The pre-defined order can be B₀, A₀, B₁, A₁ and B₂.

In one embodiment, assume the position, width and height of the current block are (x, y), W and H respectively, the pre-defined positions can include positions immediately above the current block, such as (x+W>>1, y−1) or (x+(W+1)>>1, y−1), if W is greater than or equal to a threshold TH. The pre-defined positions can also include positions immediately left to the current block, such as (x−1, y+H>>1) or (x−1, y+(H+1)>>1), if H is greater than or equal to a threshold TH. TH can be 2, 4, 8, 16, 32, or 64.

In one embodiment, there is a maximum number of inherited models from spatial neighbours that can be added into the candidate list, and the maximum number is smaller than the number of pre-defined positions.

### V.3. Inheriting Temporal Neighbouring Model Parameters

In one embodiment, if the current slice/picture is a non-intra slice/picture, the inherited model parameters can be from the block in the previous coded slices/pictures.

In one embodiment, the current block position is at (x, y) and the block size is w×h. The inherited model parameters can be from the block at some pre-defined positions of the previous coded slices/picture.

In one sub-embodiment, the pre-defined positions can be the same as the temporal candidate positions in inter merge mode.

In one sub-embodiment, the pre-defined positions can be (x+Δx, y+Δy) or (x_{mid}+Δx, y_{mid}+Δy), where

$$( {x}_{m i d} , {y}_{mid} ) = ( x + \frac{w}{2} , y + \frac{h}{2} ) .$$

The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j ,$$

$${α}_{y} = \{ {α}_{y 1} , {α}_{y 2} , {α}_{y 3} , … , {α}_{yn} \} , {α}_{yi} < {α}_{yj} if i < j .$$

All values in αₓ and α_{y} are positive numbers.

For example, (Δx, Δy) can be (±αₓᵢ×w, ±α_{yi}×h), (±αₓᵢ×w, 0), (0, ±α_{yi}×h).

For another example, (Δx, Δy) can be (±αₓᵢ×δx, ±α_{yi}×δy), (±αₓᵢ×δx, 0), (0, ±α_{yi}×δy), where δx and δy are two fixed positive numbers.

For yet another example, αₓ=α_{y}, such as αₓ=α_{y}={1, 2, 3, 4, 5}.

For yet another example, αₓ≠α_{y}, such as αₓ={1/2, 1, 3/2, 2, 5/2} and α_{y}={1, 2, 3, 4, 5}.

In one sub-embodiment, the pre-defined positions (x′, y′) are inside the corresponding area of the current encoding block, i.e., x≤x′<x+w and y≤y′<y+h. The pre-defined positions can be (x, y), (x+w−1, y), (x, y+h−1), (x+w−1, y+h−1), (x+w/2, y+h/2), (x, y+h/2), (x+w/2, y).

In one sub-embodiment, the pre-defined positions (x′, y′) are outside of the corresponding area of the current encoding block, i.e., x′<x+ or x′≥x+w, and y′<y or y′≥y+h. The pre-defined positions can be (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In one embodiment, the models from the positions closer to (x_{mid}, y_{mid}) are added into the final merge candidate list first. In one embodiment, the models from the positions closer to (x, y) are added into the final merge candidate list first.

The previous coded picture, from which the inherited parameter model is obtained, is referred to as the collocated picture hereafter.

In one embodiment, the previous coded picture where the inherited parameter model is from, i.e., the collocated picture, is one of the pictures in the reference lists.

In one embodiment, the collocated picture from which the inherited parameter model is obtained is the same picture as the collocated picture in inter merge mode.

In one embodiment, the collocated picture is signalled in the picture/slice header. The reference list and the reference index are signalled in the picture/slice header. For example, the collocated picture is selected as L0[0]. For another example, the collocated picture is selected as L1[0]. In one embodiment, the collocated picture is selected as the picture in the reference lists, where the POC difference between selected reference picture and the current picture is the smallest. For example, if the POC of current picture is 8, the POCs of pictures in reference list 0 are {7, 6, 5, 0} and POCs of pictures in reference list 1 are {7, 6, 5, 4}, then L0[0] (equivalent to L1[0]) is selected since its POC difference is the smallest. In another sub-embodiment, if there are two pictures whose POC difference between them and the current picture are both the smallest, the picture with the smaller POC is selected. For example, if the POC of current picture is 2, the POCs of pictures in reference list 0 are {0, 4, 8} and POCs of pictures in reference list 1 are {8, 16, 32}, then L0[0] (POC=0) is selected. In another sub-embodiment, if there are two pictures whose POC difference between them and the current picture are both the smallest, the picture with the larger POC is selected. For example, if the POC of current picture is 2, the POCs of pictures in reference list 0 are {0, 4, 8} and POCs of pictures in reference list 1 are {8, 16, 32}, then L0[1] (POC=4) is selected. In another sub-embodiment, if there are two pictures whose POC difference between them and the current pictures are both the smallest, the picture with smaller QP difference between it and the current picture is selected. For example, if the POC of current picture is 2, and the QP of current picture is 28. The POCs and QPs of the pictures in reference list 0 are {0, 4, 8} and {19, 26, 23}. The POCs and QPs of the pictures in reference list 1 are {8, 16, 32} and {23, 22, 21}. Then L0[1] (POC=4 and QP=26) is selected. In still another embodiment, if there are two pictures whose POC difference between them and the current picture are both the smallest, the picture with the smaller QP is selected. In still another embodiment, if there are two pictures whose POC difference between them and the current picture are both the smallest, the picture with the larger QP is selected.

In one embodiment, the collocated picture is selected as the picture in the reference lists whose QP difference between it and the current picture is the smallest. For example, if the QP of the current picture is 28, and the QPs of the pictures in reference list 0 are {19, 26, 23} and the QPs of the pictures in reference list 1 are {23, 22, 21}, then L0[1] is selected. In another sub-embodiment, if there are more than one picture in the reference lists whose QP difference between them and the current picture are the smallest, the picture with the smaller QP is selected. In another sub-embodiment, if there are more than one picture whose QP difference between them and the current picture are the smallest, the picture with the larger QP is selected. In another sub-embodiment, if there are more than one picture whose QP difference between them and the current picture are the smallest, the picture with the smaller POC distance is selected.

In one embodiment, the collocated picture is selected as the picture in the reference lists whose QP is the smallest. In another embodiment, the collocated picture is selected as the picture in the reference lists whose QP is the largest.

In one embodiment, the previous coded picture where the inherited parameter model is from (i.e., the collocated picture), is the most recently coded I-picture. The cross-component model information of the most recently coded I-slice/picture is stored in a long-term reference buffer.

In one embodiment, the collocated picture and the positions where the inherited parameter model is from are determined by the motion vector of a neighbouring block. For example, if the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy. Δx and Δy are set to the L0 horizontal and vertical motion vector of the neighbouring block, and the collocated picture is the L0 reference picture indicated by the L0 motion vector of the neighbouring block. In still another embodiment, if the neighbouring block is inter bi-prediction, Δx and Δy are set to the L1 horizontal and vertical motion vector of the neighbouring block, and the collocated picture is the L1 reference picture indicated by the L1 motion vector of the neighbouring block. In one embodiment, the neighbouring block is the left block of the current block. In another embodiment, the neighbouring block is the above block of the current block.

In one embodiment, the positions in the previous coded slices/pictures where the inherited parameter model is from is determined by the motion vector of a neighbouring block. Let Δx and Δy be the horizontal and vertical displacement determined based on the selected motion vector of the neighbouring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

In another embodiment, the inherited model parameters can also be from the block positions in the patterns described in earlier paragraphs. The positions are centred at (x′, y′), which is defined as in previous paragraph. For example, let the current block size be w×h. The two value sets a, and ay are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j .$$

All values in αₓ and α_{y} are positive numbers. The inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, y′), (x′−αₓᵢ×w, y′), (x′, y′+α_{yi}×h), (x′, y′−α_{yi}×h) of the previous coded slices/picture. For another example, let 8x and 8y be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, y′), (x′−αₓᵢ×δx, y′), (x′, y′+α_{yi}×δy), (x′y′−α_{yi}×δy) of the previous coded slices/picture. For another example, the inherited model parameters can be from the block at some pre-defined positions relative to (x′, y′) of the previous coded slices/picture. The positions can be

$$( {x}^{′} , {y}^{′} ) , ( {x}^{′} + w - 1 , {y}^{′} ) , ( {x}^{′} , {y}^{′} + h - 1 ) , ( {x}^{′} + w - 1 , {y}^{′} + h - 1 ) ,$$

$$( {x}^{′} + \frac{w}{2} , {y}^{′} + \frac{h}{2} ) .$$

For another example, the positions can be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h).

In one embodiment, the neighbouring block can be at a pre-defined position. For example, the position can be at the A₀ position as described in FIG. 5. The pre-defined position can also be at A₁, B₀, B₁, B₂. If the block at the pre-defined position is not an inter block, no neighbouring block is selected.

In another embodiment, when selecting the neighbouring block, there can be a list of pre-defined positions. The positions are placed according to the checking order. For example, the positions can be the spatial position described in FIG. 5. The selected neighbouring block can be the first position in the list that is an inter block. The L0 motion vector is selected. If the L0 motion vector is not available, select the L1 motion vector. For another example, the L1 motion vector is selected. If the L1 motion vector is not available, select the L0 motion vector.

For another example, the positions in the list are checked in the pre-defined checking order. For each position, the L0 motion vector is first checked, and then the L1 motion vector. For another example, the L1 motion vector is first checked, and then the L0 motion vector. The selected motion vector is the first motion vector in the checking order whose reference picture is the collocated picture.

In one embodiment, the horizontal and vertical displacement Δx and Δy are determined based on the selected motion vector of the neighbouring block. For example, if the reference picture of the selected motion vector and the collocated picture are the same picture, Ax equals to the horizontal part of the selected motion vector and Ay equals to the vertical part of the selected motion vector. If the horizontal part or the vertical part of the selected motion vector is fractional, Ax equals to the horizontal part of the selected motion vector after rounding and Ay equals to the vertical part of the selected motion vector after rounding. The rounding method used can be but not limited to the following methods: rounding toward negative infinity, rounding toward positive infinity, rounding toward zero, or rounding to the nearest integer (e.g., rounding away from zero, rounding half up, rounding half down, . . . ). For another example, if the reference picture of the selected motion vector and the collocated picture are not the same. The reference picture can be one of the pictures in the reference list, while the collocated picture is signalled in the picture/slice header. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb). If mv_x*(td/tb) or mv_y*(td/tb) is fractional, Δx equals to mv_x*(td/tb) after rounding or the horizontal part of the selected motion vector after rounding and Δy equals to mv_y*(td/tb) after rounding or the vertical part of the selected motion vector after rounding. The rounding method used can be, but not limited to, the following methods: rounding toward negative infinity, rounding toward positive infinity, rounding toward zero, or rounding to the nearest integer (e.g., rounding away from zero, rounding half up, rounding half down, . . . )

In one embodiment, the inherited model parameters are derived by using the luma and chroma reconstruction samples of the collocated block. Let the current block position be at (x, y) and the block size is w×h. The collocated block is a block positioned at (x′, y′) in the collocated picture with block size w×h, when the inherited model is from position (x′, y′). For another example, the collocated block can be a block positioned at (x′, y′) in the collocated picture with block size m×n, where m and n are fixed positive values. For example, the collocated block can be at (x, y). For another example, if Δx and Δy are the L0 horizontal and vertical motion vector of the neighbouring block, and the collocated picture is the L0 reference picture indicated by the L0 motion vector of the neighbouring block, the collocated block can be at (x+Δx, y+Δy) in the collocated picture. (x′, y′) can be the block positions in the patterns described in earlier paragraphs. For example, (x′, y′) can be (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), (x, y−α_{yi}×h).

In one embodiment, the cross-component parameter model can be inherited from more than one previous coded pictures. The cross-component parameter model can be inherited from any picture in a picture set, which contains N previous coded pictures. An index can be signalled/parsed in the bitstream to indicate the selected picture. The index ranges from 0 to N−1. In one sub-embodiment, the picture whose POC difference between it and the current picture is smaller is associated with the smaller index. In another sub-embodiment, the picture whose QP difference between it and the current picture is smaller is associated with the smaller index. In another sub-embodiment, the picture whose QP is smaller is associated with the smaller index. In another sub-embodiment, the picture whose QP is larger is associated with the smaller index.

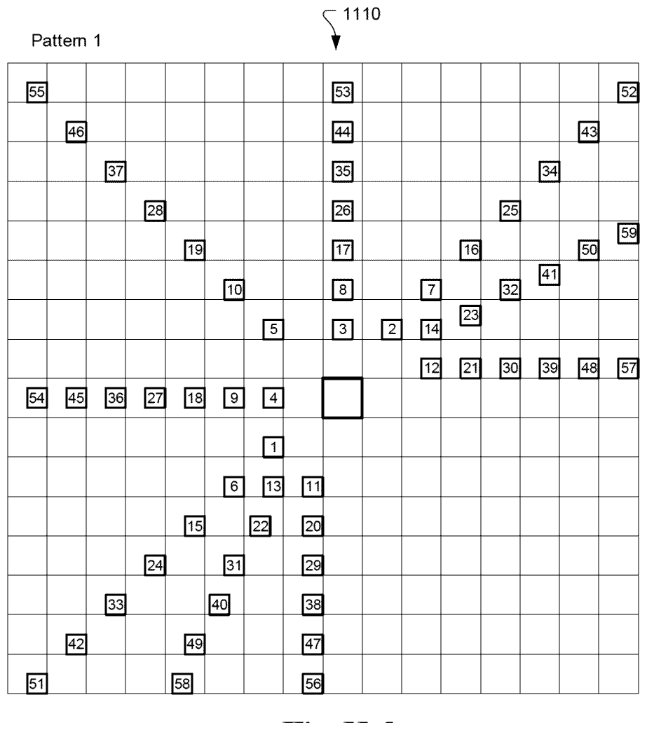

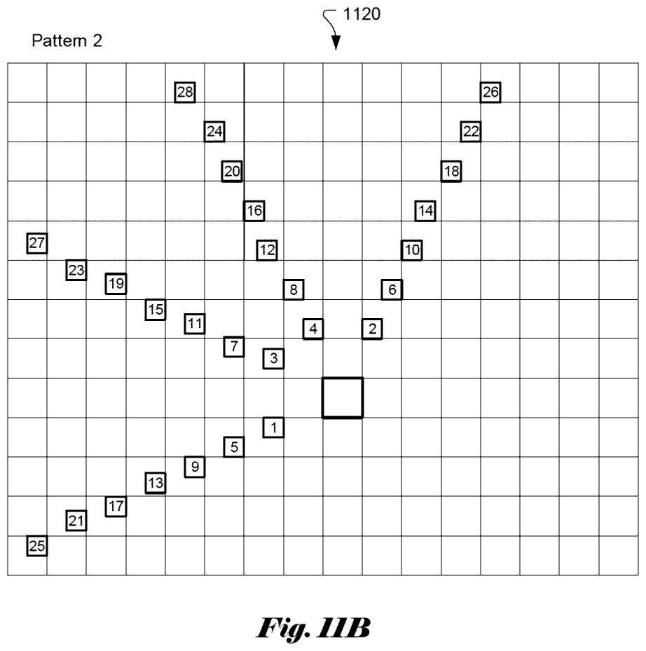

In one embodiment, as shown in FIG. 10, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy.

In one sub-embodiment, if the prediction mode of the current block is inter, Δx and Δy are set to the horizontal and vertical motion vector of the current block.

In another sub-embodiment, if the current block is inter bi-prediction, Δx and Δy are set to the horizontal and vertical motion vector in reference picture list 0.

In another sub-embodiment, if the current block is inter bi-prediction, Δx and Δy are set to the horizontal and vertical motion vector in reference picture list 1.

### V.4. Inheriting Non-Adjacent Spatial Neighbouring Models

In one embodiment, the inherited model parameters can be from blocks that are non-adjacent spatial neighbouring blocks. The models from blocks at pre-defined positions are added into the candidate list in a pre-defined order.

In one sub-embodiment, the pre-defined positions and the pre-defined order are the same as those of non-adjacent spatial neighbouring candidates for inter merge mode.

In one sub-embodiment, the pre-defined positions and the pre-defined order are as depicted in FIG. 11A and FIG. 11B. The positions of the numbered squares are the pre-defined positions. The number inside each square indicate the pre-defined order. Positions in Pattern 1 (1110) is added into the list before positions in Pattern 2 (1120). The distance between each pre-defined positions are proportional to the width and height of the current block.

In one embodiment, there is a maximum number of inherited models from non-adjacent spatial neighbours that can be added into the candidate list, and the maximum number is smaller than the number of pre-defined positions.

V.5. Inheriting Model Parameters from History Table

In one embodiment, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In one embodiment, the adding order of historical candidate can be from the beginning of the table to the end of the table. In another embodiment, the adding order of historical candidate can be from a certain pre-defined position to the end of the table. In another embodiment, the adding order of historical candidate can be from the end of the table to the beginning of the table. In another embodiment, the adding order of historical candidate can be from a certain pre-defined position to the beginning of the table. In another embodiment, the adding order of historical candidate can be in an interleaved manner (e.g., the first added candidate is from the beginning of the table, the second added candidate is from the end of the table and so on).

In one embodiment, one cross-component model history table can be maintained for storing the previous cross-component model (i.e., CCM information), and the cross-component model history table can be reset at the start of the current picture, current slice, current tile, every M CTU rows or every N CTUs, N and M can be any value greater than 0. In another embodiment, the cross-component model history table can be reset at the end of the current picture, current slice, current tile, current CTU row or current CTU.

In another embodiment, one picture can be divided into several regions, and for each region, a history table is kept. The history table 0 and one additional history table will be updated during the encoding/decoding process. The additional history table can be determined by the current position. For example, if the current CU is located in the second region, the additional history table to be updated is history table 2.

In another embodiment, multiple history table are used for different updated frequencies. For example, the first history table is updated every CU, the second history table is updated every two CUs, the third history table is updated every four CUs and so on.

In another embodiment, multiple history table are used for storing different type of cross-component model. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In another embodiment, multiple history table are used for different reconstructed luma intensity. For example, if the average of reconstructed luma samples in the current block are greater than a pre-defined threshold, the cross-component model will be stored in the first history table; otherwise, the cross-component model will be stored in the second history table. In another embodiment, multiple history table are used for different reconstructed chroma intensities. For example, if the average of neighbouring reconstructed chroma samples in the current block are greater than a pre-defined threshold, the cross-component model will be stored in the first history table; otherwise, the cross-component model will be stored in the second history table.

In one embodiment, when adding historical candidates from multiple history tables to the candidate list, the adding order can be from the beginning of to the end of a certain table, and then the next history table is added in the same order or in a reversed order. In another embodiment, the adding order can be from the end of the certain table to the beginning of the certain table, and then the next history table is added in the same order or in a reversed order. In another embodiment, the adding order can be from the certain pre-defined position of the certain table to the end of the certain table, and then the next history table is added in the same order or in a reversed order. In another embodiment, the adding order can be from the certain pre-defined position of the certain table to the beginning of the certain table, and then the next history table is added in the same order or in a reversed order. In another embodiment, the adding order of historical candidate can be in an interleaved manner in a certain history table (e.g., the first added candidate is from the beginning of the certain history table, the second added candidate is from the end of the certain history table and so on), and then add the next history table in the same order or in a reversed order.

In another embodiment, the adding order can be from the beginning of each history table to the end of each history table. In another embodiment, the adding order can be from the end of each history table to the beginning of each history table. In another embodiment, the adding order can be from the certain pre-defined position of each history table to the end of each history table. In another embodiment, the adding order can be from the certain pre-defined position of each history table to the beginning of each history table. In another embodiment, the adding order of historical candidate can be in an interleaved manner in each certain history table (e.g., the first added candidates are from the beginning of all history tables, the second added candidates are from the end of all history tables and so on).

In one embodiment, multiple cross-component model history tables are used, but not all history tables will be used for creating the candidate list. Only history tables whose regions are close to the region of the current block can be used to create the candidate list.

In one embodiment, if the historical candidates are used, the range for selecting non-adjacent candidates can be reduced by using smaller distance between each position of non-adjacent candidates. In another embodiment, if the historical candidates are used, the number of non-adjacent candidates can be reduced by measuring the distance from the left-top position of the current block to the candidate position, and then exclude the candidate with the distance greater than a pre-defined threshold. In another embodiment, if the historical candidates are used, the number of non-adjacent candidates can be reduced by skipping the candidates that are not located in the same region. In another embodiment, if the historical candidates are used, the number of non-adjacent candidates can be reduced by skipping the candidates that are not located in the neighbouring regions. The range of neighbouring regions is pre-defined, and it can be M by N regions where M and N can be any value greater than 0. In another embodiment, if the historical candidates are used, the range for selecting non-adjacent candidates can be reduced by skipping the second search pattern.

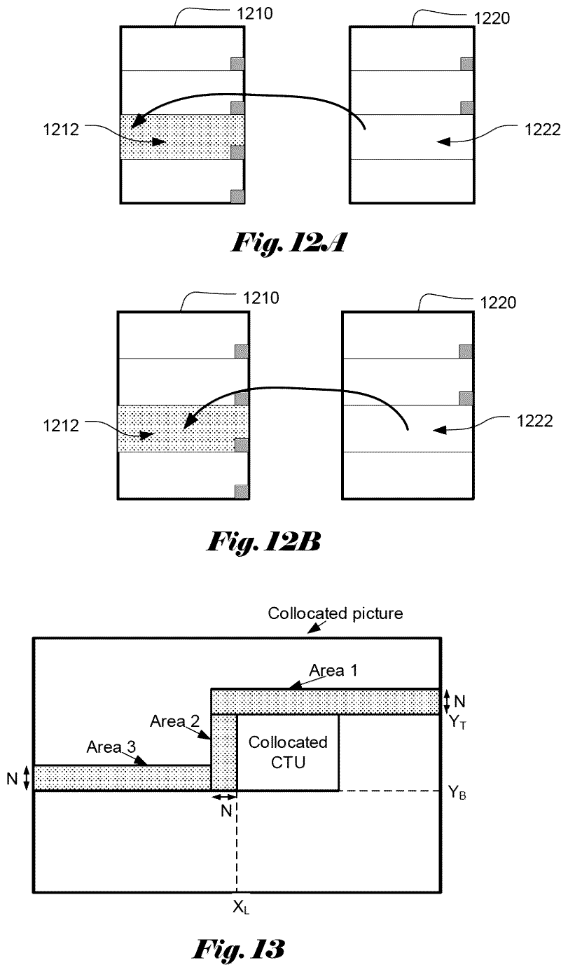

In another embodiment, one picture can be divided into several regions, and at least one history table is kept in each region. For a region of the current picture, it can use or combine the history tables of one or multiple regions in the previous coded pictures as the initial history table. For example, if a picture is divided into N regions, it can implicitly or explicitly select the history table from one of N regions in the previous coded pictures as the initial history table. The index of one of N regions can be signalled or implicitly derived from the corresponding region in the previous coded pictures. As shown in FIGS. 12A-B, the corresponding region in the previous coded pictures can be the region has the same beginning geometric position of the current region or contain the centre geometric position of the current region. For another example, it can combine more than one history table in the previous coded regions/pictures to construct the history table of the current region. For example, it can combine the first k candidates in each history table in the previous coded regions/picture. For example, when combining candidates in history tables in the previous coded regions/picture, the candidates in the history table of the left region are included before the candidates in the history table of the above region. For example, when combining candidates in history tables in the previous coded regions/picture, the candidates in the history table of the above region are included before the candidates in the history table of the left region.

As shown in FIGS. 12A-B, where the current picture 1220 is a P/B coded picture and the previous picture 1210 is an Intra coded picture. Each picture is divided into 4 regions as shown in 4 rectangular boxes. According to an embodiment of the present invention, the corresponding region in the previous coded pictures can be the region 1212 having the same beginning geometric position as the current region 1222 as shown in FIG. 12A or containing the centre geometric position of the current region 1222 as shown in FIG. 12B.

V.6. Inheriting from Fusion Mode

Fusion mode refers to mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by chroma intra fusion mode, the model parameters for obtaining the CCP coded intra prediction are inherited and further refined.

In one embodiment, in addition to inheriting and refining the CCP model parameters, the fusion weight, the coding mode of non-CCP coded intra prediction are also inherited. That is, the chroma intra fusion mode is inherited.

### V.7. Available Region of Temporal Candidates

To limit the requirement of buffer/storage resource, the available range for including temporal candidates should be constrained. The temporal candidates mentioned in this section refer to candidates that inherit model parameters from the block in the previous coded slices/pictures as described in Section entitled “Inheriting temporal neighbouring model parameters”. For example, assume the current block position is at (x, y), the positions in the previous coded slices/pictures, where the inherited parameter model is from, can be (x+Δxi, y+Δyi), i is from 1 to M, and M is a positive integer greater than 0. Δxᵢ and Δyᵢ are pre-defined displacements. For another example, assume the current block position is at (x, y), the positions in the previous coded slices/pictures, where the inherited parameter model is from, can be (x+dx+Δxᵢ, y+dy+Δyᵢ), i is from 1 to M, and M is a positive integer greater than 0. Δxᵢ and Δyᵢ are pre-defined displacements, dx and dy are determined by a motion vector of a neighbouring block of the current block. The details of how to determine the motion vector is in Section entitled “Inheriting temporal neighbouring model parameters”.

In one embodiment, if the prediction mode of the current block is inter, dx and dy are set to the horizontal and vertical parts of motion vector of the current block. If the horizontal part or the vertical part of the motion vector is fractional, dx is set to the horizontal part of the motion vector after rounding and dy is set to the vertical part of the motion vector after rounding. The rounding method used can be but not limited to the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k can be 2, 4, 8, 16, or 32). If the prediction mode of the current block is IBC, dx and dy are set to the horizontal and vertical block vector of the current block. If the horizontal part or the vertical part of the block vector is fractional, dx is set to the horizontal part of the block vector after rounding and dy is set to the vertical part of the block vector after rounding. The rounding method used can be, but not limited to, the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k can be 2, 4, 8, 16, or 32).

In one embodiment, only the cross-component model (CCM) information of the collocated picture in the CTU whose position in the collocated picture corresponds to the position of the current encoding CTU in the current picture can be referenced by temporal candidates. In another embodiment, only the CCM information of the collocated picture in the CTUs whose positions in the collocated picture correspond to the position of current encoding CTU, and/or left N CTUs, and/or right M CTUs in current picture can be referenced by temporal candidates, where N and M can be any integer greater than 0. In another embodiment, only the CCM information of the collocated picture in the CTU row whose position in collocated picture corresponds to the position of current encoding CTU row in current picture can be referenced by temporal candidates. In another embodiment, only the positions in collocated picture correspond to current CTU row and/or the above N CTU rows and/or below M CTU rows of the current picture can be referenced, where N and M can be any integer greater than 0. Note, as described in Section entitled “Inheriting CCM information”, the CCM information mentioned in this disclosure includes, but not limited to, prediction mode (e.g., CCLM, MMLM, CCCM), GLM pattern index, model parameters, or classification threshold.

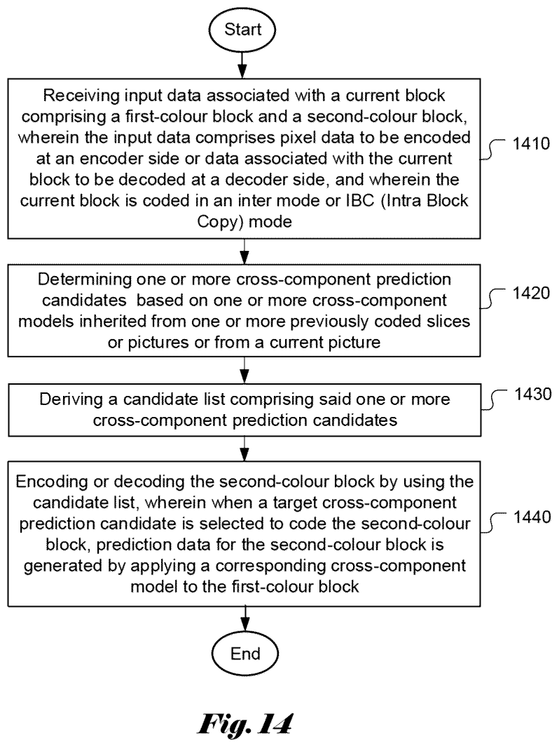

In FIG. 13, the collocated CTU refers to the CTU in the collocated picture whose position corresponds to the position of the current encoding CTU in the current picture. Let the position of the top-left and bottom left corner of the collocated CTU be (x_{L}, y_{T}) and (x_{L}, y_{B}) respectively. Let the picture width be w. The x, y ranges for each dotted area are defined as following:

$$Area 1 : {x}_{L} - N \leq x < w , {y}_{T} - N \leq y < {y}_{T}$$

$$Area 2 : {x}_{L} - N \leq x < {x}_{L} , {y}_{T} \leq y \leq {y}_{B}$$

$$Area 3 : 0 \leq x < {x}_{L} - N , {y}_{B} - N < y \leq {y}_{B}$$

N is any positive integer, N>0.

In one embodiment, the temporal candidates can only refer the CCM information in the collocated CTU, in Area1, in Area2 or in Area3, as depicted in FIG. 13. N is set to a pre-defined value. For example, N is set to the minimum allowed block size in the spec. The block can be CU/PU/TU. For another example, N is set to 4.

In one embodiment, the region from which the temporal candidates can refer the CCM information is the same as the region from which the temporal motion vector can be referred in inter mode. That is, the available region of temporal candidates comprising CCM information is the same as the available region of temporal candidates, which comprise motion vector information, in inter merge mode.

V.8. Removing or Modifying Similar Model Parameters when Adding Candidates into a History Table

When adding cross-component model into a history table, it can further check the similarity between the to-be-added model and the existing models in the history table. If the to-be-added model is similar to the existing models, the to-be-added model will not be included in the history table. In one embodiment, it can compare the similarity of (α×lumaAvg+β) or α among existing candidates to decide whether to include the to-be-added model or not. For example, if the (α×lumaAvg+β) or α of the to-be-added model is the same as one of the existing candidates, the to-be-added model is not included. For another example, if the difference of (α×lumaAvg+β) or α between the to-be-added model and one of existing models is less than a threshold, the to-be-added model is not included. Besides, the threshold can be adaptive based on coding information (e.g., the current block size or area). For another example, when comparing the similarity, if a to-be-added model and the existing model both use CCCM, it can compare similarity by checking the value of (c₀C+c₁N+c₂S+c₃E+c₄W+c₅P+c₆B) to decide whether to include the to-be-added model or not. In another embodiment, if the CU position of the current to-be-added model is the same CU position as the existing candidates, the to-be-added model parameter is not included. In still another embodiment, if the to-be-added model is similar to one of existing candidate models, it can adjust the inherited model parameters to let the to-be-added model be different from the existing candidate models. For example, if the to-be-added scaling parameter is similar to one of existing candidate models, the to-be-added scaling parameter can be added with a predefined offset (e.g., 1>>S or −(1>>S), where S is the shift parameter) to let the to-be-added model be different from the existing candidate models.

In another embodiment, it can only compare partial model parameters with the existing models in the history table. For example, a CCLM candidate has scale and offset parameters, it can only compare to determine whether the scale or offset parameters is the same or similar to existing candidates or not. If the scale or offset parameters is the same or similar, the to-be-added model will not be included into the history table. For another example, a CCCM candidate has c₀ to c₆ parameters, it can only compare to determine whether n parameters (n<7) are the same or similar to existing candidates or not. If the scale or offset parameters is the same or similar, the to-be-added model will not be included into the history table.

In another embodiment, it can apply a to-be-added model to the neighbouring reconstruction samples of the current block, and compare the difference with the existing candidate models. If the difference value is less than or equal to a threshold, the to-be-added model will not be included into the history table. For example, assume the applied result is

$${p}_{j}^{n e i}$$

and the corresponding results of the existing models in the history table are

$${p}_{0}^{n e i} to {p}_{i}^{n e i} .$$

### If

$$\vert {p}_{j}^{n e i} - {p}_{0}^{n e i} \vert < th , \vert {p}_{j}^{n e i} - {p}_{1}^{n e i} \vert < th , … , or \vert {p}_{j}^{n e i} - {p}_{i}^{n e i} \vert < th ,$$

the to-be-added model will not be included in the history table. For the selection of the neighbouring reconstruction samples, it can choose the neighbouring reconstruction sample with the maximal value, the neighbouring reconstruction sample with the minimal value, the mean/median/mode of the neighbouring reconstruction samples, the left-side neighbouring reconstruction samples, the above-side neighbouring reconstruction samples, or the above-left neighbouring reconstruction samples.

In another embodiment, the number of candidates that have the same type (e.g., MMLM, CCCM, or GLM) is limited when including the candidates into the history table. For example, if the current history table has k candidates with MMLM type, it is not allowed to further include candidates with MMLM type into the history table. For another example, if the current history table has k candidates with CCCM type, it is not allowed to further include candidates with CCCM type into the history table. For another example, if the current history table has k candidates with GLM type, it is not allowed to further include candidates with GLM type into the history table.

In another embodiment, the constraints, or rules to prevent adding a redundant candidate into a history table will share/be the same as that of preventing to add a redundant candidate into a candidate list.

### VI. Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the pre-defined order can be spatial adjacent candidates, temporal candidates, spatial non-adjacent candidates, historical candidates, and then default candidates.

In another embodiment, if all the pre-defined neighbouring and historical candidates are added but the maximum candidate number is not reached, some default candidates are added into the candidate list until the maximum candidate number is reached.

In one embodiment, the default candidates can be CCLM models. The scaling parameter α is from the set {0, 1/8, −1/8, +2/8, −2/8, +3/8, −3/8, +4/8, −4/8, . . . , +N/8, −N/8}, where N is a positive integer. The offset parameter β can be 1/(1<<bit_depth) or can be derived based on neighbouring luma and chroma samples. For example, if the average value of neighbouring luma and chroma samples are lumaAvg and chromaAvg, β=chromaAvg−α·lumaAvg. In one sub-embodiment, the inclusion order of the default candidates can depend on the absolute value and the sign of the scaling parameter α. For example, the default candidates are added into the list in the following order: α=0, 1/8, −1/8, +2/8, −2/8, +3/8, −3/8, +4/8, −4/8, . . . , +N/8, −N/8.

In another embodiment, a default candidate can be an earlier candidate with a delta scaling parameter refinement. The earlier candidate is a CCLM model. If the scaling parameter of an earlier candidate is α, the scaling parameter of a default candidate is (α+Δα). For example, Δα can be 0, 1/8, −1/8, +2/8, −2/8, +3/8, −3/8, +48, −48, . . . , +N/8, −N/8, where N is a positive integer. For example, Δα can be 0, 1/8, −1/8, +2/8, −2/8, +3/8, −3/8, +4/8, −4/8. The offset parameter β can be derived based on (α+Δα) and the average value of neighbouring luma and chroma samples of the current block. In one sub-embodiment, the earlier candidate is the first CCLM candidate added into the list. In one sub-embodiment, the inclusion order of the default candidates can depend on the absolute value and the sign of the refinement Δα. For example, the default candidates are added into the list in the following order: Δα=0, 1/8, −1/8, +2/8, −2/8, +3/8, −3/8, +48, −48, . . . , +N/8, −N/8.

### VII. Removing or Modifying Similar Neighbouring Model Parameters

When inheriting cross-component model parameters from other blocks, it can further check the similarity between the inherited model and the existing models in the candidate list or those model candidates derived by the neighbouring reconstruction samples of the current block (e.g., models derived by CCLM, MMLM, or CCCM using the neighbouring reconstruction samples of the current block). If the model of a candidate parameter is similar with the existing models, the model would not be included into the candidate list.

### VIII. Reordering the Candidates in the List

The candidates in the list can be reordered to reduce the syntax overhead when signalling the selected candidate index.

In one embodiment, the reordering rules can depend on the coding information of neighbouring blocks or the model error. For example, if neighbouring above or left blocks are coded by MMLM, the MMLM candidates in the list can be moved to the head of the current list.

In one embodiment, the reordering rule is based on the model error by applying the candidate model to the neighbouring templates of the current block, and then compare the error with the reconstruction samples of the neighbouring template.

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g., the proposed CCLM extension/variation in this invention). One variation is MMLM that uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g., CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

Any of the foregoing proposed methods of deriving temporal cross-component model information can be implemented in encoders and/or decoders. For example, any of the proposed methods can be implemented in an inter/intra/prediction/IBC/quantization module of an encoder, and/or an inter/intra/prediction/IBC/quantization module of a decoder. Alternatively, any of the proposed methods of deriving temporal cross-component model information can be implemented as a circuit coupled to the inter/intra/prediction module of the encoder and/or the inter/intra/prediction/IBC/quantization module of the decoder, so as to provide the information needed by the inter/intra/prediction/IBC/quantization module.

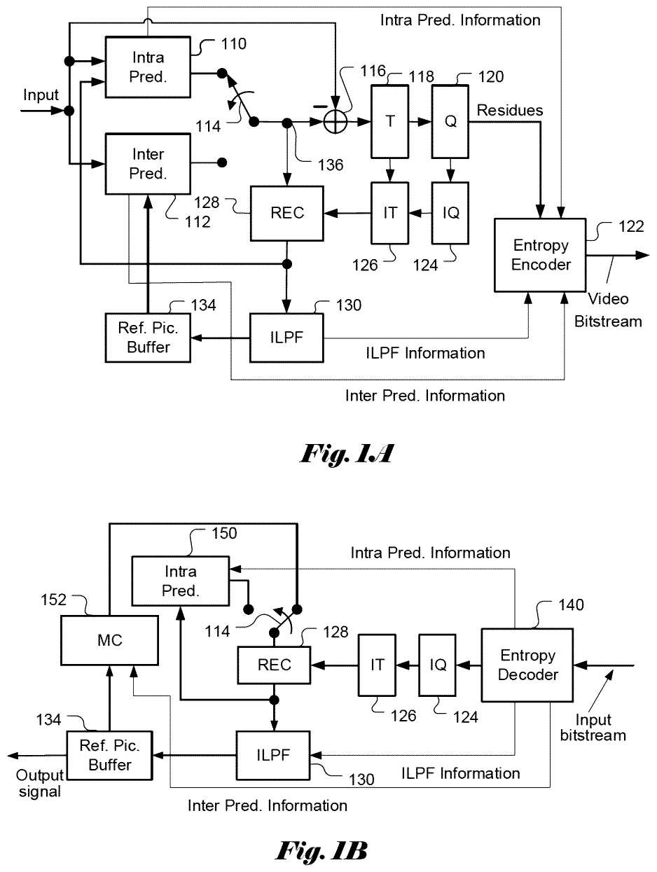

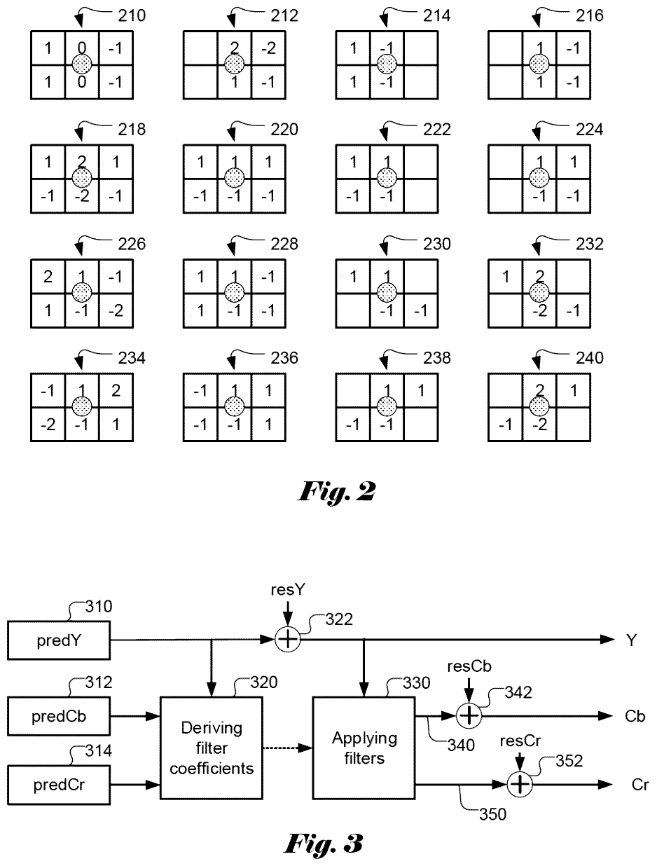

The method of deriving temporal cross-component model information can be implemented in an encoder side or a decoder side. For example, any of the proposed methods of deriving temporal cross-component model information can be implemented in an Intra/Inter coding module (e.g. Intra Pred. 150/MC 152 in FIG. 1B) in a decoder or an Intra/Inter coding module in an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 14 illustrates a flowchart of an exemplary video coding system that derives cross-component prediction candidates based on cross-component models inherited from previously coded slices or pictures or from a current picture for chroma coding according to an embodiment of the present invention. According to this method, input data associated with a current block comprising a first-colour block and a second-colour block is received in step 1410, wherein the input data comprises pixel data to be encoded at an encoder side or data associated with the current block to be decoded at a decoder side, and wherein the current block is coded in an inter mode or IBC (Intra Block Copy) mode. One or more cross-component prediction candidates are determined based on one or more cross-component models inherited from one or more previously coded slices or pictures or from a current picture in step 1420. A candidate list comprising said one or more cross-component prediction candidates is derived in step 1430. The second-colour block is encoded or decoded by using the candidate list in step 1440, wherein when a target cross-component prediction candidate is selected to code the second-colour block, prediction data for the second-colour block is generated by applying a corresponding cross-component model to the first-colour block.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprises pixel data to be encoded at an encoder side or data associated with the current block to be decoded at a decoder side, and wherein the current block is coded in an inter mode or IBC (Intra Block Copy) mode;
determining one or more cross-component prediction candidates based on one or more cross-component models inherited from one or more previously coded slices or pictures or from a current picture;
deriving a candidate list comprising said one or more cross-component prediction candidates; and
encoding or decoding the second-colour block by using the candidate list, wherein when a target cross-component prediction candidate is selected to code the second-colour block, prediction data for the second-colour block is generated by applying a corresponding cross-component model to the first-colour block.

2. The method of claim 1, wherein target cross-component models are inherited from one or more collocated blocks in said one or more previously coded slices or pictures, and said one or more collocated blocks are indicated by inter mode information.

3. The method of claim 2, wherein the collocated block is indicated by the inter mode information of the current block.

4. The method of claim 2, wherein if the current block is coded in a subblock motion mode, one or more subblock temporal candidates corresponding to one or more subblock temporal cross-component models inherited from one or more collocated blocks indicated by the inter mode information of said one or more subblocks are added to the candidate list.

5. The method of claim 2, wherein the collocated block is referred by the inter mode information of one or more neighbouring blocks of the current block.

6. The method of claim 1, wherein said one or more cross-component prediction candidates are located at one or more pre-defined positions in said one or more previously coded slices or pictures according to current location of the current block, current block width, current block height, or a combination thereof.

7. The method of claim 6, wherein said one or more pre-defined positions are inside a corresponding area of the current block or said one or more pre-defined positions are outside the corresponding area of the current block.

8. The method of claim 6, wherein a first set of values and a second set of values are determined, and said one or more pre-defined positions comprise one or more offset locations from the current location of the current block, and wherein said one or more offset locations comprise the first set of values scaled by the current block width for a horizontal direction, the second set of values scaled by the current block height for a vertical direction, or both.

9. The method of claim 1, wherein a collocated picture is determined, and wherein the collocated picture corresponds to a target previously coded picture that a target cross-component model is inherited from.

10. The method of claim 9, wherein the collocated picture corresponds to one of reference pictures in one or more reference lists.

11. The method of claim 9, wherein the collocated picture is selected according to a reference index and a target reference list signalled in or parsed from a picture header or a slice header.

12. The method of claim 9, wherein the collocated picture is selected as a target reference picture in one or more reference lists, and POC (Picture Order Count) difference or QP (Quantization Parameter) difference between the target reference picture and a current picture is the smallest.

13. The method of claim 9, wherein the collocated picture corresponds to a most recently coded I-picture.

14. The method of claim 9, wherein both the collocated picture and positions of said one or more cross-component prediction candidates or only the positions of said one or more cross-component prediction candidates are determined according to a motion vector of a neighbouring block or the current block.

15. The method of claim 14, wherein when the collocated picture corresponds to a target reference picture associated with the motion vector of the neighbouring block or the current block, the positions of said one or more cross-component prediction candidates are determined according to the motion vector of the neighbouring block or the current block shifted by a set of pre-defined values.

16. The method of claim 14, wherein the positions of said one or more cross-component prediction candidates are determined according to a scaled motion vector shifted by a set of pre-defined values, and wherein the scaled motion vector is derived based on the motion vector of the neighbouring block scaled by a ratio of a first POC (Picture Order Count) distance for a current reference picture and a second POC distance for the collocated picture.

17. The method of claim 14, wherein the neighbouring block is selected from a pre-defined position.

18. The method of claim 17, wherein if the neighbouring block at the pre-defined position is not an inter block, the neighbouring block is not used to derive said one or more cross-component prediction candidates.

19. The method of claim 14, wherein the neighbouring block is selected from a set of pre-defined positions according to a pre-defined checking order.

20. The method of claim 19, wherein a first neighbouring block, according to the pre-defined checking order, having a corresponding reference picture being the collocated picture is selected as the neighbouring block.

21. The method of claim 1, wherein positions of said one or more cross-component prediction candidates are determined according to a block vector of a neighbouring block or the current block.

22. The method of claim 21, wherein the positions of said one or more cross-component prediction candidates are determined according to a block vector shifted by a set of pre-defined values.

23. An apparatus for coding colour pictures using coding tools including one or more cross component models related modes, the apparatus comprising one or more electronic circuits or processors arranged to:
receive input data associated with a current block comprising a first-colour block and a second-colour block, wherein the input data comprises pixel data to be encoded at an encoder side or data associated with the current block to be decoded at a decoder side, and wherein the current block is coded in an inter mode;
determine one or more temporal candidates based on one or more temporal cross-component models inherited from one or more previously coded slices or pictures;
derive a candidate list comprising said one or more temporal candidates; and
encode or decode the second-colour block by using the candidate list, wherein when a target temporal candidate is selected to code the second-colour block, prediction data for the second-colour block is generated by applying a corresponding temporal cross-component model to the first-colour block.
